(19) United States
(12) Patent Application Publication
(10) Pub. No.: US 2007/0047549 A1
(43) Pub. Date: Mar. 1, 2007

(54) Dual-stack network apparatus and broadcasting method thereof

(75) Inventor: Hyun-wook Park, Gwacheon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/489,576

(22) Filed: Jul. 20, 2006

(30) Foreign Application Priority Data
Aug. 25, 2005 (KR) 2005-78156

(51) Int. Cl. H04L 12/56

(52) U.S. Cl. 370/392; 370/401

(57) ABSTRACT

A dual-stack network apparatus and a broadcasting method are provided. The broadcasting method is provided with transforming data created by an application into a packet and generating an IP packet using the IP address of a target network apparatus, looking up the Ethernet address of the target network apparatus in the ARP cache table, broadcasting an ARP request packet to the network if the Ethernet address is not found in the ARP cache table, receiving an ARP reply packet for the ARP request packet from the target network apparatus and transmitting the IP packet using the data included in the ARP reply packet. As a result, the number of broadcast packets can be significantly reduced, thereby reducing network load and improving network processing efficiency.

### CROSS-REFERENCE TO RELATED APPLICATIONS

This application claims all benefits accruing under 35 U.S.C. §119 from Korean Patent Application No. 2005-78156, filed on Aug. 25, 2005, in the Korean Intellectual Property Office, the disclosure of which is incorporated by reference herein.

### BACKGROUND OF THE INVENTION

1. Field of the Invention

The present invention relates to a dual-stack network apparatus and a broadcasting method thereof, more particularly, to a dual-stack network apparatus that can reduce network load by reducing the number of broadcast packets and a broadcasting method thereof.

2. Related Art

TCP/IP is the basic network protocol widely used in the Internet or other TCP/IP networks. The TCP/IP standard protocols can be used to transmit and receive messages or files between network apparatuses, i.e., network devices or nodes which can be hosts, such as PCs, workstations, mainframes, file servers, and other types of computers, used to originate or receive messages or files in the form of data packets, via the TCP/IP network, or routers used to forward data packets between hosts and other routers within the TCP/IP network.

TCP/IP is a two-layer program consisting of TCP (transmission control protocol) and IP (internetworking protocol). TCP, the upper layer protocol, transmits messages or files through the Internet in smaller packets and reassembles received packets to original messages. IP, the lower layer protocol, processes each IP address of the packet, so that data packets can accurately reach their destinations.

IP has been improved through a series of design modifications. Currently, IPv4 (IP version 4) is widely used over the Internet. IPv4 is advantageous in that it is relatively simple and flexible. However, given the breakneck pace of change in the computer industry and the growth of the number of connected networks, IPv4 has significant limitations and shortcomings that need to be addressed and upgraded, including the lack of available IP address space (i.e., only 32 bits long IP addresses), IP performance issues including ineffective processing of IP packet routing, IP security issues, and auto-configuration issues including complicated setting for activation of IP nodes, etc. IPv6 has been developed to address IPv4's limitations and shortcomings.

Recently, new networks based on IPv6 are emerging, and existing networks are gradually being replaced with IPv6-based networks. However, it is impossible to replace all the IPv4-based hosts and routers with IPv6-based hosts and routers, since there are perhaps 100 million or more systems, scattered across the globe, with untold numbers of different versions of TCP/IP networking software running on different operating systems (OS) and hardware platforms. As a result, IPv4 and IPv6 will co-exist and will be used together for some time to come.

Thus, dual-stack network apparatuses are now used to support both IPv4 and IPv6. As shown in FIG. 1, the dual-stack network apparatus is provided with a protocol stack configuration, including an application 5, a TCP/UDP (user datagram protocol) layer 10, an IPv4 layer 20, an ARP (address resolution protocol) layer 40, an IPv6 layer 30, an ICMPv6 layer 45 and an Ethernet driver 50.

The Ethernet driver 50 receives an IPv4 packet and an IPv6 packet from the IPv4 layer 20 and the IPv6 layer 30, respectively, and transmits these packets along with Ethernet headers.

The TCP/UDP layer 10 identifies sender or target address of each packet received or transmitted from Ethernet driver 50 as determined by the application 5.

The IPv4 layer 20 and the IPv6 layer 30 generate an IPv4 address and an IPv6 address, respectively, by processing the address portion of each packet.

The ARP layer 40 and the ICMPv6 layer 45 map the IPv4 address and the IPv6 address, respectively, into an Ethernet address, which is a physical hardware address used in data linking as required in TCP/IP packet-based networks such as Ethernet or Token Ring. ARP is typically used to perform address resolution between IP addresses and various link-layer addresses.

The data transmission process from the dual-stack network apparatus A to a network apparatus B supporting both IPv4 and IPv6 B can be described as follows.

Data transmission using IPv4 is as follows. Data created by the application 5 of the network apparatus A is transformed into an IPv4 packet by the TCP/UDP layer 10 and the IPv4 layer 20. The ARP layer 40 then broadcasts an ARP request packet to the network. After receiving the ARP request packet, the network apparatus B transmits an ARP reply packet to the network apparatus A and thus informs its Ethernet address. The network apparatus A transmits the IPv4 packet to the network apparatus B referring to the received Ethernet address.

Data transmission using IPv6 is as follows. Data created by the application 5 of the network apparatus A is transformed into an IPv6 packet by the TCP/UDP layer 10 and the IPv4 layer 20. A neighbor discovery packet is then broadcasted to the network to find out the Ethernet address of the network apparatus B. After receiving the neighbor discovery packet, the network apparatus B transmits a reply packet to the network apparatus A and thus informs its Ethernet address. The network apparatus A transmits the IPv6 packet to the network apparatus B referring to the received Ethernet address.

In such a conventional dual-stack network apparatus A, an ARP request packet has to be broadcasted to the network for data to be transmitted to the network apparatus B by IPv4. In addition, a neighbor discovery packet has to be broadcasted to the network for data to be transmitted to the network apparatus B by IPv6 in the same dual-stack network apparatus A. That is, different packet has to be broadcasted for IPv4 and IPv6 for Ethernet address request, even if data transmission is carried out in the same network apparatuses.

As such, the number of broadcast packets in current network systems using both IPv4 and IPv6 can increase up to twice the amount, when compared with network systems using only IPv4 or only IPv6. The increased number of broadcast packets increases network load and lowers processing performance and efficiency of the network.

### SUMMARY OF THE INVENTION

Various aspects and example embodiments of the present invention provide a dual-stack network system capable of reducing network load by decreasing number of broadcast packets and a broadcasting method thereof.

Additional aspects and/or advantages of the invention will be set forth in part in the description which follows and, in part, will be obvious from the description, or may be learned by practice of the invention.

In accordance with an aspect of the present invention, a broadcasting method comprises: transforming data created by an application into a packet and generating an IP packet referring to the IP address of a target network apparatus; looking up an Ethernet address of the target network apparatus in an ARP cache table; broadcasting an ARP request packet, via a network, if no Ethernet address is found in the ARP cache table; receiving an ARP reply packet for the ARP request packet from the target network apparatus, via the network; and transmitting the IP packet using the data included in the ARP reply packet.

According to an aspect of the present invention, the ARP cache table, the ARP request packet and the ARP reply packet may include Ethernet addresses, IPv4 addresses and IPv6 addresses of the sender and target network apparatuses. An IP packet may be generated using IPv4 or IPv6 protocol address depending on the application.

During the broadcasting of the ARP request packet, an ARP request packet requesting an Ethernet address and an IPv6 address of the target network apparatus is broadcasted for an IP packet including an IPv4 address; and an ARP request packet requesting an Ethernet address and an IPv4 address of the target network apparatus is broadcasted for an IP packet including an IPv6 address.

According to an aspect of the present invention, the method further comprises determining whether a specific symbol is included in the target Ethernet address of the ARP request packet if the target network apparatus receives the ARP request packet. If the symbol is included in the target Ethernet address, an ARP reply packet is generated including Ethernet address and IPv6 address or IPv4 address of the target network apparatus, for the ARP request packet including the IPv4 address or IPv6 address, and is then transmitted to the sender network apparatus. However, if the symbol is not included in the target Ethernet address, an ARP reply packet is generated including the Ethernet address of the target network apparatus, and is then transmitted to the sender network apparatus.

Preferably, the Ethernet address, the IPv4 address and the IPv6 address of the target network apparatus included in the ARP reply packet are stored in the ARP cache table.

When the Ethernet address and the IPv6 address or the IPv4 address of the target network apparatus are received, the IP packet may be transmitted by IPv6 or IPv4 protocol referring to the Ethernet address stored in the ARP cache table. When there is an Ethernet address of the target network apparatus in the ARP cache table, an IP packet is transmitted to the target network apparatus.

In accordance with another aspect of the present invention, a dual-stack network apparatus is provided with an ARP cache table in which information of the target network apparatus is stored; an ARP packet generation module that generates an ARP request packet to be transmitted, via a network, to the target network apparatus; an ARP determination module that looks up an Ethernet address of the target network apparatus in the ARP cache table after receiving the IP packet from the sender network apparatus, and broadcasts the ARP request packet, via the network, if no Ethernet address is found; and an ARP cache table management module that stores the information of an ARP reply packet for the ARP request packet from the target network apparatus in the ARP cache table.

According to an aspect of the present invention, the Ethernet addresses the IPv4 addresses and the IPv6 addresses of the sender and target network apparatuses, are included in the ARP cache table, the ARP request packet and the ARP reply packet. And, preferably, a specific symbol is included in the ARP request packet replacing the target Ethernet address.

According to an aspect of the present invention, the ARP packet generation module generates an ARP request packet requesting an Ethernet address and an IPv6 address of the target network apparatus for an IP packet in which an IPv4 address is included, and generates an ARP request packet requesting an Ethernet address and an IPv4 address of the target network apparatus for an IP packet in which an IPv6 address is included.

According to an aspect of the present invention, an ARP packet processing module is further provided that, after receiving the ARP request packet, checks the target Ethernet address, and determines if an ARP reply packet including an Ethernet address and an IPv4 address or an IPv6 address is to be generated depending upon whether there is a predetermined specific symbol in the target Ethernet address.

According to an aspect of the present invention, the ARP packet processing module can control the ARP packet generation module so that an ARP reply packet in which an Ethernet address and an IPv6 address or an IPv4 address of the target network apparatus are included is generated for the ARP request packet including IPv4 address or IPv6 address.

The ARP determination module may, after receiving the Ethernet address and IPv6 address or IPv4 address of the target network apparatus, permit the IP packet be transmitted, via the network using IPv6 or IPv4 protocol, to the same target network apparatus referring to the Ethernet address stored in the ARP cache table. When there is an Ethernet address of the target network apparatus in the ARP cache table, the ARP determination module may let the IP packet be transmitted to the target network apparatus, via the network.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates a protocol stack configuration of a typical dual-stack network apparatus;

FIG. 2 illustrates an example protocol stack configuration of a dual-stack network apparatus according to an embodiment of the present invention;

FIG. 3 illustrates an example configuration of a new ARP packet according to an embodiment of the present invention;

FIG. 4 is a block diagram of a broadcast control system of the dual-stack network apparatus according to an embodiment of the present invention;

FIG. 5 is a flow chart of a broadcasting process of the broadcast control system shown in FIG. 4 installed at a sender network apparatus according to an embodiment of the present invention; and

FIG. 6 is a flow chart of a broadcasting process of the broadcast control system shown FIG. 4 installed at a target network apparatus according to an embodiment of the present invention.

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

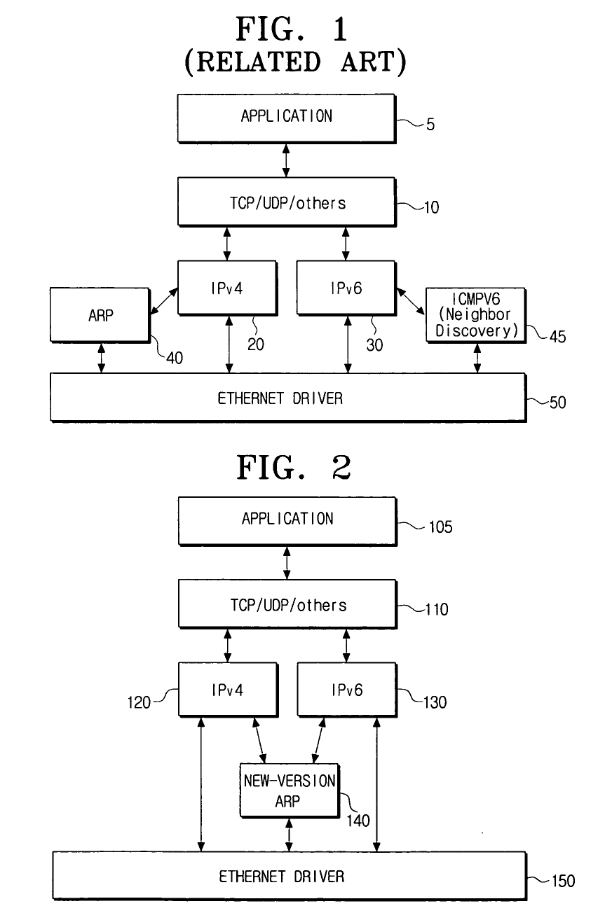

FIG. 2 is a block diagram illustrating an example protocol stack configuration of a dual-stack network apparatus according to an embodiment of the present invention. As shown in FIG. 2, the protocol stack configuration of the dual-stack network apparatus includes an application 105, a TCP/UDP (user datagram protocol) layer 110, an IPv4 layer 120, an IPv6 layer 130, a new ARP layer 140 and an Ethernet driver 150.

The TCP/UDP layer 110, the IPv4 layer 120 and the IPv6 layer 130 play the same roles as described in connection with the typical dual-stack network apparatus shown in FIG. 1.

However, the new ARP layer 140 generates an ARP request packet of the new version to map the IPv4 address or IPv6 address into an Ethernet address used in packet-based networks such as Ethernet or Token Ring. Since the new ARP request packet is capable of requesting IPv4 address or IPv6 address as well as the Ethernet address of the target network apparatus, Ethernet address and IPv4 address or IPv6 address of the target network apparatus can be ascertained with a single broadcasting.

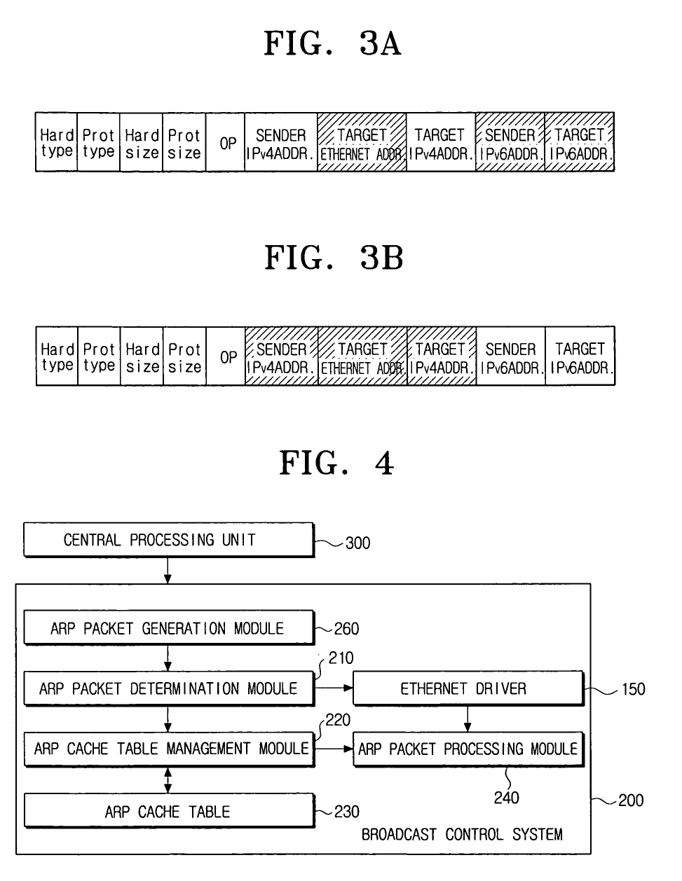

FIGS. 3A-3B show an example ARP packet according to an embodiment of the present invention. As shown in FIG. 3A and FIG. 3B, the newARP packet includes different portions for hardware address type (Hard type), protocol address type (Prot type), hardware address size (Hard size), protocol address size (Prot size), determining whether the packet is for request or reply (OP), sender Ethernet address, sender IPv4 address, target Ethernet address, target IPv4 address, sender IPv6 address and target IPv6 address.

Different portions of the new ARP packet are used depending upon whether the broadcasting is performed at the sender network apparatus via IPv4 or IPv6. For example, when the broadcasting is performed via IPv4, the sender IPv4 address and the target IPv4 address are recorded in the new ARP packet, with the sender IPv6 address and the target IPv6 address leaving blank and a specific symbol is included in the target Ethernet address, as indicated by hatched portions, shown in FIG. 3A.

On the other hand, when the broadcasting is performed via IPv6, the sender IPv6 address and the target IPv6 address are recorded with the sender IPv4 address and the target IPv4 address leaving blank and a specific symbol is included in the target Ethernet address, as indicated by hatched portions, shown in FIG. 3B.

Conventionally, the target Ethernet address was left blank when transmitting an ARP request packet from the sender network apparatus to the target network apparatus, via the packet-based network. However, in accordance with the present invention, a specific symbol showing indicating that the corresponding packet is a new ARP request packet is inserted when the packet is transmitted from the sender network apparatus to the target network apparatus. For example, a symbol such as ‘0xa0a0a0’ is inserted so that the target network apparatus recognizes the ARP request packet as new ARP request packet.

As the target network apparatus recognizes the new ARP request packet, the new ARP reply packet can be transmitted including the target Ethernet address and the IPv4 address or IPv6 address if the target network apparatus supports both IPv4 and IPv6 protocols. If the target network apparatus supports only one of IPv4 and IPv6 protocols, only the target Ethernet address is included in the new ARP reply packet.

If the target network apparatus supports only one of IPv4 and IPv6 protocols, the target network apparatus sends a reply by including only the address of the pertinent protocol. That is, if the target network apparatus supports IPv4 only, the target network apparatus transmits the ARP reply packet to the sender network apparatus, including only the Ethernet address and leaving the IPv6 address blank. Otherwise, if the target network apparatus supports IPv6 only, the target network apparatus transmits the ARP reply packet to the sender network apparatus, including only the Ethernet address and leaving the IPv4 address blank.

FIG. 4 is a block diagram illustrating a broadcast control system of a network apparatus according to an embodiment of the present invention. Such a network apparatus can be a sender network apparatus or a target network apparatus connected to a packet-based network.

The broadcast control system 200 broadcasts the ARP request packet via the protocol selected by a command from a central processing unit (CPU) 300 of the network apparatus. Such a broadcast control system 200 comprises an ARP packet generation module 260, an ARP packet determination module 210, an ARP cache table management module 220, an ARP cache table 230, and an ARP packet processing module 240.

The ARP cache table 230 stores data of the target network apparatus that has been archived. Such an ARP cache table can be incorporated into either an existing storage of the network apparatus or a new storage dedicated for archiving such data.

As can seen in Table 1, for example, below, the ARP cache table 230 contains such data as type of a target network apparatus, an Ethernet address, an IPv4 address and an IPv6 address of the target network apparatus.

TABLE 1

| Network | | | |
|---|---|---|---|
| Apparatus | Ethernet | IPv4 | |
| Type | Address | Address | IPv6 Address |
| C | 0000f0a02a92 | 192.0.0.2 | FE80::202:B3FF:FE1E:8329 |
| | 0000f0a02a93 | 192.0.0.3 | FE80::202:B3FF:FE1E:8330 |
| D | 0000f0a02a94 | 192.0.0.4 | — |
| | 0000f0a02a95 | 192.0.0.5 | — |
| E | 0000f0a02a96 | — | FE80::202:B3FF:FE1E:8331 |
| | 0000f0a02a97 | — | FE80::202:B3FF:FE1E:8332 |

As shown in Table 1, all of Ethernet address, IPv4 address and IPv6 address data are recorded for a network apparatus, for example, network apparatus C. This indicates that the network apparatus C is a dual-stack network apparatus capable of supporting both IPv4 and IPv6. However, for a network apparatus D, there is no data regarding IPv6. This is because the target IPv6 address portion of the new ARP reply packet received from the network apparatus D is blank. Thus, the network apparatus D is deemed to be a network apparatus capable of supporting IPv4 only. Similarly, for a network apparatus E, there is no data regarding IPv4. This is because the target IPv4 address portion of the new ARP reply packet received from the network apparatus E is blank. Thus, the network apparatus E is deemed to be a network apparatus capable of supporting IPv6 only.

The ARP packet generation module 260 generates an ARP request packet to be broadcasted to a packet-based network, where a target network apparatus is located in order to request the Ethernet address of the target network apparatus. Also, at the target network apparatus, the ARP packet generation module 260 generates an ARP reply packet for the ARP request packet received from the sender network apparatus. In the ARP reply packet, IPv4 address and/or IPv6 address is included along with the Ethernet address.

If target IPv4 address and sender IPv4 address are included in the ARP request packet, target Ethernet address and target IPv6 address are included in the ARP reply packet. If target IPv6 address and sender IPv6 address are included in the ARP request packet, target Ethernet address and target IPv4 address are included in the ARP reply packet.

If the ARP request packet is identified as a conventional ARP request packet, the ARP packet generation module 260 generates an ARP request packet by inserting the Ethernet address only. Likewise, even if the ARP request packet is a new ARP request packet, if the target network apparatus is not a dual-stack network apparatus, but supports only one of IPv4 and IPv6, the ARP packet generation module 260 generates an ARP request packet by inserting the Ethernet address only.

The ARP determination module 210 determines whether the ARP request packet is to be broadcasted. Such an ARP determination module 210 looks up the Ethernet address of the target network apparatus in the ARP cache table 230 during packet transmission. If the Ethernet address of the target network apparatus is found in the ARP cache table 230, the ARP determination module 210 permits the IP packet be transmitted to the Ethernet driver 150, so that it can be transmitted to the target network apparatus including the Ethernet address. Otherwise, if the Ethernet address of the target network apparatus is not found in the ARP cache table 230, the ARP determination module 210 permits the ARP packet generation module 260 to generate an ARP request packet.

The ARP cache table management module 220 sends data about the target network apparatus to the ARP determination module 210. After receiving an Ethernet address, IPv4 address or IPv6 address from the target network apparatus, the ARP cache table management module 220 archives the data in the ARP cache table 230.

When a broadcast packet is received, the ARP packet processing module 240 checks the target Ethernet address of the broadcast packet, and determines whether the packet is a new ARP request packet or a conventional ARP request packet. A packet having a predetermined specific symbol in the target Ethernet address is determined as a new ARP request packet. In contrast, a packet without such a predetermined specific symbol in the target Ethernet address is determined as a conventional ARP request packet.

And, when an ARP reply packet is received from the target network apparatus, the ARP packet processing module 240 extracts the target Ethernet address, IPv4 address or IPv6 address included in the ARP reply packet and sends the same to the ARP cache table management module 220.

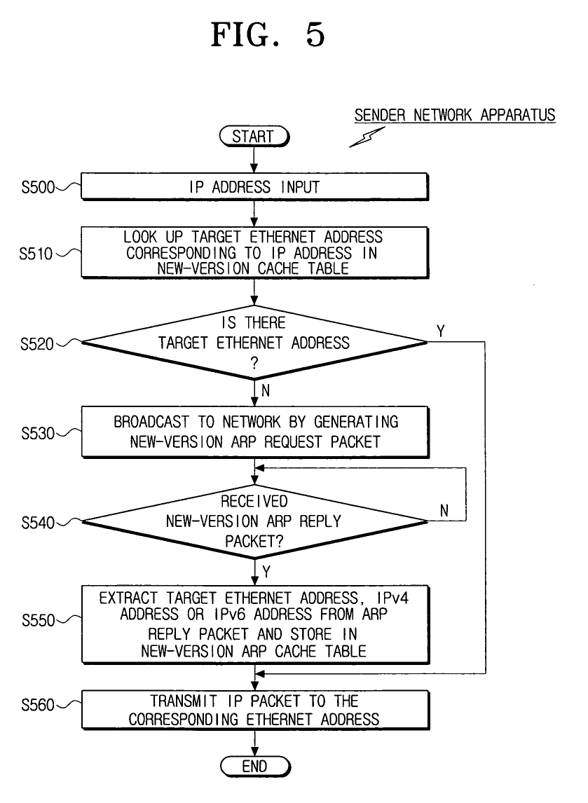

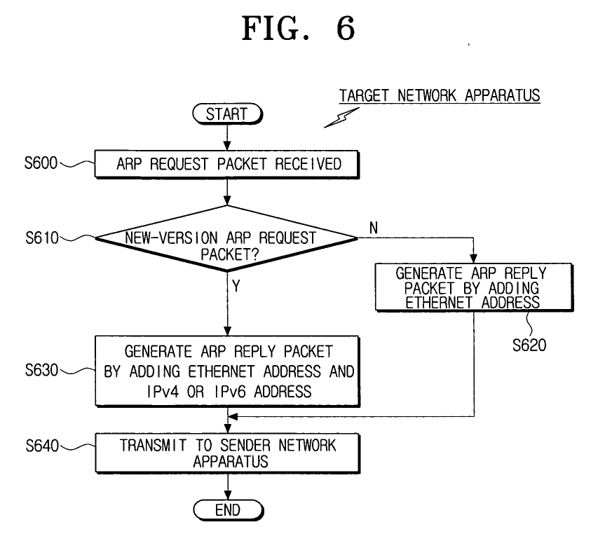

For example, if the network apparatuses are PCs, workstations, or other types of computers, and a packet broadcasting to a network printer, via a packet-based network, can be performed as described in connection with FIG. 5 and FIG. 6 as follows. Specifically, FIG. 5 illustrates an example broadcasting process of the broadcast control system, as shown in FIG. 4, installed at a sender network apparatus according to an embodiment of the present invention. Conversely, FIG. 6 illustrates an example broadcasting process of the broadcast control system, as shown FIG. 4, installed at a target network apparatus according to an embodiment of the present invention.

Turning now to FIG. 5, when a user wants to print a document created by an IPv4-based application using a PC serving as a sender network apparatus with a network printer serving as a target network apparatus, via a packet-based network, the central processing unit (CPU) 300 installed at the sender network apparatus commands that corresponding data be transmitted via the packet-based network using IPv4. Data is divided into packets by the TCP/UDP layer 110 and an IP address, i.e., an IPv4 address of the target network apparatus, i.e., network printer, selected by the IPv4 layer 120 is included in each packet at block S500.

Next, the central processing unit (CPU) 300 permits the ARP determination module 210 to look up the Ethernet address corresponding to the IPv4 address of the network printer in the ARP cache table 230 at block S510. If the Ethernet address is found in the ARP cache table 230 at block S520, the target Ethernet address is included in an IP packet and is sent to the Ethernet driver 150. Then, the Ethernet driver 150 transmits an IPv4 packet to the corresponding Ethernet address at block S560.

If the Ethernet address corresponding to the IPv4 address of the network printer is not found in the ARP cache table at block S520, the ARP determination module 210 allows the ARP packet generation module 260 to generate a new ARP request packet and broadcast the same, via the packet-based network, at block S530. Similarly to the ARP packet as shown in FIG. 3A or FIG. 3B, the Ethernet driver 150 includes the sender Ethernet address in the new ARP request packet and sends the same to the network printer, via the packet-based network.

As shown in FIG. 6, after receiving the ARP request packet at block S600, the ARP packet processing module 240 of the target network apparatus, i.e., a network printer, determines whether there is a predetermined specific symbol in the target Ethernet address of the ARP request packet at block S610. If the ARP request packet is identified as a new ARP request packet, an IPv6 address is included along with the Ethernet address of the network printer so as to generate an ARP reply packet at block S630. Then, the ARP reply packet is sent to the Ethernet driver 150, and the Ethernet driver 150 transmits the ARP reply packet to the sender network apparatus, i.e., the PC, via the packet-based network at block S640. If the received ARP request packet is not a new ARP request packet, the ARP packet processing module 240 sends the ARP reply packet to the Ethernet driver 150 after including the Ethernet address of the network printer only.

At the sender network apparatus, if the ARP reply packet from the target network apparatus, i.e., the network printer is received at block S540, the ARP packet processing module 240 of the sender network apparatus, i.e., the PC, extracts the Ethernet address, IPv4 address and IPv6 address from the ARP reply packet and sends them to the ARP cache table management module 220. The ARP cache table management module 220 then archives the corresponding data in the ARP cache table 230 at block S550. In the ARP cache table 230, a network printer type, an Ethernet address, an IPv4 address and/or an IPv6 address of the network printer are stored, as shown, for example, in Table 1.

The ARP determination module 210 includes the Ethernet address of the network printer extracted from the ARP reply packet in the IP packet and sends the same to the Ethernet driver 150. The Ethernet driver 150 adds an Ethernet header and transmits the IP packet to the target network apparatus, i.e., the network printer, via the packet-based network at block S560.

Once the Ethernet address and IPv6 address of the network printer is found out using the new ARP request packet, it is unnecessary to broadcast another ARP request packet later. This is because the IPv6 address and Ethernet address of the network printer are archived in the ARP cache table 230.

As such, the dual-stack network apparatus according an embodiment of the present invention advantageously enables seeking out the target Ethernet address and IPv4 address or IPv6 address by a single broadcasting of an ARP request packet.

Thus, once an ARP request packet is broadcasted via IPv4 during data transmission with a network apparatus, there is no need of further broadcasting for the same network apparatus, even when data transmission is performed via IPv6. Accordingly, the number of broadcast packets can be significantly reduced, which in turn reduces network load and improves network processing efficiency.

As apparent from the above description, the present invention can significantly reduce number of broadcast packets, thereby reducing network load and improving network processing efficiency.

According to an embodiment of the present invention, the ARP packet generation module 260, the ARP packet determination module 210, the ARP cache table management module 220, and the ARP packet processing module 240, as shown in FIG. 4, can be software modules written in C++ languages. However, such modules can also be written in a variety of software languages, including C, Java, Visual Basic, J2EE, SQL, Perl, Web Services, VB.NET and many other languages over the Internet. The various software modules may also be integrated in a single application executed on one or more control units (not shown), such as a microprocessor, a microcontroller, or a processor card (including one or more microprocessors or microcontrollers) in a computer system (PC). Alternatively, the software modules and individual components of each module can also be distributed in different applications or a single application executed by a single computing device connected to the packet-based network.

These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs).

Instructions of the software routines or modules may also be loaded or transported into a network apparatus which can be hosts, such as PCs, workstations, mainframes, file servers, and other types of computers, used to originate or receive messages or files in the form of data packets, via the packet-based network, or routers used to forward data packets between hosts and other routers within the packet-based network, in one of many different ways. For example, code segments including instructions stored on floppy discs, CD or DVD media, a hard disk, or transported through a network interface card, modem, or other interface device may be loaded into a network apparatus and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. As a result, many modifications, permutations, additions and sub-combinations may be made to adapt the teachings of the present invention to a particular situation without departing from the scope thereof. For example, while the packet-based network has been described in the context of a telecommunications network, it should be appreciated that the present invention is not limited to this particular telecommunications network or protocol. Rather, the invention is also applicable to other communications networks and compatible protocols, for example an Integrated Systems Digital Network (ISDN), a Voice over IP (VoIP) network, or a cellular communications system. Moreover, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Lastly, the ARP cache table can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A broadcasting method of a dual-stack network apparatus comprising:
transforming data created by an application into a packet and generating an IP packet referring to the IP address of a target network apparatus;
looking up an Ethernet address of the target network apparatus in an ARP cache table;
broadcasting an ARP request packet, via a network, if no Ethernet address is found in the ARP cache table;
receiving an ARP reply packet for the ARP request packet from the target network apparatus, via the network; and
transmitting the IP packet using the data included in the ARP reply packet.

2. The broadcasting method as claimed in claim 1, wherein the ARP cache table, the ARP request packet and the ARP reply packet include the Ethernet addresses, the IPv4 addresses and the IPv6 addresses of the sender and target network apparatuses.

3. The broadcasting method as claimed in claim 1, wherein the IP packet is generated using IPv4 or IPv6 protocol address depending on the application.

4. The broadcasting method as claimed in claim 3, wherein, in the broadcasting of the ARP request packet, an ARP request packet requesting an Ethernet address and an IPv6 address of the target network apparatus is broadcasted if the IP packet includes an IPv4 address, and an ARP request packet requesting Ethernet address and IPv4 address of the target network apparatus is broadcasted if the IP packet includes an IPv6 address.

5. The broadcasting method as claimed in claim 4, further comprising determining whether a specific symbol is included in the target Ethernet address of the ARP request packet if the ARP request packet is received by the target network apparatus.

6. The broadcasting method as claimed claim 5, further comprising:
generating an ARP reply packet including the Ethernet address and IPv6 address or IPv4 address of the target network apparatus; and
transmitting the ARP reply packet to the sender network apparatus, via the network, with respect to the ARP request packet including Pv6 address or IPv4 address, if the specific symbol is included in the target Ethernet address.

7. The broadcasting method as claimed in claim 5, further comprising:
generating an ARP reply packet including the Ethernet address of the target network apparatus; and
transmitting the ARP reply packet to the sender network apparatus, via the network, unless the specific symbol is included in the target Ethernet address.

8. The broadcasting method as claimed in claim 6, further comprising storing the Ethernet address, IPv4 address and IPv6 address of the target network apparatus included in the ARP reply packet in the ARP cache table.

9. The broadcasting method as claimed in claim 7, further comprising storing the Ethernet address of the target network apparatus included in the ARP reply packet in the ARP cache table.

10. The broadcasting method of claim 8, wherein the IP packet is transmitted to the target network apparatus, via the network, using an IPv6 or IPv4 protocol referring to the Ethernet address archived in the ARP cache table, if the Ethernet address and the IPv4 address or the IPv6 address of the target network apparatus are received.

11. The broadcasting method of claim 9, wherein the IP packet is transmitted to the target network apparatus, via the network, using an IPv6 or IPv4 protocol referring to the Ethernet address archived in the ARP cache table, if the Ethernet address of the target network apparatus is received.

12. The broadcasting method as claimed in claim 1, further comprising transmitting the IP packet to the target network apparatus, via the network, if the Ethernet address of the target network apparatus is found in the ARP cache table.

13. A dual-stack network apparatus comprising:
an ARP cache table in which data about a target network apparatus is stored;
an ARP packet generation module to generate an ARP request packet to be transmitted to the target network apparatus, via a network;
an ARP determination module to enable the ARP request packet to be broadcasted, via the network, if the Ethernet address of the target network apparatus is not found in the ARP cache table; and
an ARP cache table management module to store data included in an ARP reply packet received from the target network apparatus, via the network, for the ARP request packet in the ARP cache table.

14. The dual-stack network apparatus as claimed in claim 13, wherein the ARP cache table, the ARP request packet and the ARP reply packet include the Ethernet address, the IPv4 address and the IPv6 address of the sender and target network apparatuses.

15. The dual-stack network apparatus as claimed claim 14, wherein the ARP request packet includes a specific symbol instead of the target Ethernet address.

16. The dual-stack network apparatus as claimed in claim 13, wherein the ARP packet generation module generates an ARP request packet requesting an Ethernet address and an IPv6 address of the target network apparatus if an IPv4 address is included in the IP packet, and generates an ARP request packet requesting an Ethernet address and an IPv4 address of the target network apparatus if an IPv6 address is included in the IP packet.

17. The dual-stack network apparatus as claimed in claim 16, wherein the ARP packet processing module checks the target Ethernet address of the received ARP request packet, and determines whether an ARP reply packet including Ethernet address and IPv4 address or IPv6 address is to be generated depending on the presence or absence of a predetermined specific symbol in the target Ethernet address.

18. The dual-stack network apparatus as claimed in claim 17, wherein the ARP packet processing module controls the ARP packet generation module, so that an ARP reply packet in which Ethernet address and IPv6 address or IPv4 address of the target network apparatus is to be generated for the ARP request packet including the IPv4 address or IPv6 address.

19. The dual-stack network apparatus as claimed in claim 13, wherein the ARP determination module permits the IP packet to be transmitted to the target network apparatus, via the network, using an IPv6 or IPv4 protocol referring to the Ethernet address stored in the ARP cache table, after receiving Ethernet address and IPv6 address or IPv4 address of the target network apparatus.

20. The dual-stack network apparatus as claimed in claim 13, wherein the ARP determination module permits the IP packet to be transmitted to the target network apparatus, via the network, if the Ethernet address of the target network apparatus is found in the ARP cache table.

21. A network device comprising:
a processor configured to select between an IPv4 and IPv6 protocols used for data transmission, via a network;
an ARP (address resolution protocol) cache table to store information of at least a target network device; and
a broadcast control system configured to transform data created by an application into an IP packet referring to an IP address of a target network device, to look up an Ethernet address of the target network device stored in the ARP cache table, to broadcast an ARP request packet, via the network, if no Ethernet address of the target network device is found in the ARP cache table, to receive an ARP reply packet from the target network apparatus, via the network, and to transmit the IP packet using the information included in the ARP reply packet.

22. The network device as claimed in claim 21, wherein the ARP cache table, the ARP request packet and the ARP reply packet include Ethernet addresses, IPv4 addresses and IPv6 addresses of sender and target network devices.

23. The network device as claimed in claim 21, wherein the IP packet is generated using an IPv4 or IPv6 protocol address depending on the application.

24. The network device as claimed in claim 21, wherein the ARP request packet requesting an Ethernet address and an IPv6 address of the target network device is broadcasted if the IP packet includes an IPv4 address, and alternatively, the ARP request packet requesting an Ethernet address and an IPv4 address of the target network device is broadcasted if the IP packet includes an IPv6 address.

25. The network device as claimed in claim 21, wherein the ARP reply packet includes an Ethernet address and an IPv4 address or an IPv6 address of the target network device if the target network device supports both IPv4 and IPv6 protocols, and wherein the ARP reply packet includes only an Ethernet address of the target network device if the target network device supports only one of IPv4 and IPv6 protocols.

26. The network device as claimed in claim 24, wherein the Ethernet address, the IPv4 address and the IPv6 address of the target network device included in the ARP reply packet are stored in the ARP cache table.

27. The network device as claimed in claim 21, wherein the IP packet is transmitted to the target network device, via the network, using an IPv6 or IPv4 protocol referring to the Ethernet address archived in the ARP cache table, if the Ethernet address and the IPv4 address or the IPv6 address of the target network device is received.
